(19) United States
(12) Patent Application Publication
(10) Pub. No.: US 2026/0253871 A1
(43) Pub. Date: Aug. 27, 2026

(54) ELECTRODE SLURRY COMPOSITION FOR LITHIUM ION BATTERY AND ELECTRODE MANUFACTURED THEREOF FOR LITHIUM ION BATTERY

(71) Applicant: UIF (University Industry Foundation), Yonsei University, Seoul (KR)

(72) Inventors: Sang-Young LEE, Seoul (KR); Hyunseo KANG, Seoul (KR); Jung-Hui KIM, Seoul (KR)

(73) Assignee: UIF (University Industry Foundation), Yonsei University, Seoul (KR)

(21) Appl. No.: 19/550,920

(22) Filed: Feb. 26, 2026

(30) Foreign Application Priority Data
Feb. 26, 2025 (KR) 10-2025-0024964

(51) Int. Cl. H01M 4/1391; B60L 50/64; C09D 5/24; C09D 7/20; C09D 7/61; C09D 101/28; C09D 109/06; C09D 127/16; H01M 4/04; H01M 4/62; H01M 10/0525

(52) U.S. Cl. CPC H01M 4/1391; B60L 50/64; C09D 5/24; C09D 7/20; C09D 7/61; C09D 101/286; C09D 109/06; C09D 127/16; H01M 4/0404; H01M 4/623; H01M 4/625; H01M 10/0525; H01M 2220/20

(57) ABSTRACT

The present invention relates to an electrode slurry composition for a lithium ion battery and an electrode for a lithium ion battery manufactured using the same. More specifically, the electrode slurry composition for a lithium ion battery of the present invention has the advantages that, by mixing a first solvent and a second solvent of specific components into the electrode slurry composition, the binder, conductive material, and electrode active material can be uniformly distributed during drying, the migration phenomenon of the electrode active material is suppressed to enable the manufacture of a high-loading electrode, adhesion to the current collector is excellent, and the manufacturing process is simple. Furthermore, the life characteristics and electrochemical stability of the high-loading electrode can be remarkably improved.

### CROSS-REFERENCE TO RELATED APPLICATIONS

This application claims priority to Korean Patent Application No. 10-2025-0024964 filed on Feb. 26, 2025, and all the benefits accruing therefrom under 35 U.S.C.119, the contents of which in its entirety are herein incorporated by reference.

### BACKGROUND

### 1. Field

The present invention relates to an electrode slurry composition for a lithium ion battery and an electrode for a lithium ion battery manufactured using the same.

### 2. Description of Related Art

In order to secure high energy density in electric vehicles (EVs) and energy storage systems (ESS), the demand for high-loading positive electrodes that increase the content of the positive electrode active material per area is increasing, and thus research on technologies to increase the loading amount of the electrode mixture layer has been conducted. An electrode is manufactured by coating an electrode slurry on a current collector, followed by drying and rolling processes, and in order to increase the loading amount of the electrode mixture layer, a large amount of electrode slurry must be coated on the current collector. That is, in order to increase the coating amount of the electrode slurry, a higher level of coating uniformity is required.

However, this approach exhibits “drying dynamics” in which the binder/conductive material moves to the upper part of the electrode along with the solvent during the slurry drying process, and a “coffee-ring effect” in which the positive electrode active material moves to the edge of the slurry according to the Marangoni flow within the slurry. These phenomena cause a decrease in adhesion with the current collector, formation of cracks in the electrode, and uneven distribution of the active material within the electrode, thereby limiting the manufacture of high-loading electrodes.

### REFERENCES

Korean Patent Publication No. 10-2024-0103986

### SUMMARY

The present invention has been devised to solve the problems as described above, and an object of the present invention is to provide an electrode slurry composition for a lithium ion battery in which a capillary suspension structure is formed.

In addition, an object of the present invention is to provide an electrode slurry composition for a lithium ion battery that has excellent adhesion to a current collector and in which an active material, a conductive material, and a binder are uniformly distributed within the electrode.

In addition, an object of the present invention is to provide an electrode for a lithium ion battery manufactured using the electrode slurry composition of the present invention.

In addition, an object of the present invention is to provide a lithium ion battery comprising the electrode of the present invention.

In addition, an object of the present invention is to provide a device comprising the lithium ion battery of the present invention.

In addition, an object of the present invention is to provide a method for manufacturing an electrode for a lithium ion battery.

An aspect of the present invention relates to an electrode slurry composition for a lithium ion battery comprising: a first solvent; a second solvent; an electrode active material; a binder; and a conductive material; wherein the first solvent has a Snyder polarity index of 5.5 or more, the second solvent has a Snyder polarity index of 4.5 or less, and a volume ratio of the first solvent to the second solvent is 100:2.1 to 5.9.

Another aspect of the present invention relates to an electrode for a lithium ion battery manufactured using the electrode slurry composition of the present invention.

Another aspect of the present invention relates to a lithium ion battery comprising the electrode of the present invention.

Another aspect of the present invention relates to a device comprising the lithium ion battery of the present invention, wherein the device is at least one selected from a communication device, a transportation device, an electronic device, and an energy storage device.

Another aspect of the present invention relates to a method for manufacturing an electrode for a lithium ion battery comprising: (a) preparing an electrode slurry precursor comprising a first solvent, an electrode active material, a binder, and a conductive material; (b) mixing a second solvent into the electrode slurry precursor to prepare an electrode slurry composition for a lithium ion battery; and (c) coating the electrode slurry composition on a substrate and then drying it to manufacture an electrode for a lithium ion battery.

The electrode slurry composition for a lithium ion battery of the present invention has the advantages that, by mixing a first solvent and a second solvent of specific components into the electrode slurry composition, the binder, conductive material, and electrode active material can be uniformly distributed during drying, the migration phenomenon of the electrode active material is suppressed to enable the manufacture of a high-loading electrode, adhesion to the current collector is excellent, and the manufacturing process is simple. Furthermore, the life characteristics and electrochemical stability of the high-loading electrode can be remarkably improved.

Specifically, the electrode slurry composition of the present invention shows remarkably improved performance compared to the conventional electrode slurry (Comparative Example 1), such as an improvement in low-shear viscosity by about 6.2 times (657,740 cP vs. 106,490 cP), an increase in the uniform thickness securing section of the electrode by about 1.8 times (20.7 cm vs. 11.4 cm), and a capacity retention rate of 80% or more even after 100 cycles of charging and discharging.

The effects of the present invention are not limited to the effects mentioned above. It should be understood that the effects of the present invention include all effects inferable from the following description.

### BRIEF DESCRIPTION OF THE DRAWINGS

FIG. 1 is a cross-sectional view of an electrode slurry composition according to an embodiment of the present invention. In FIG. 1, an overview of the entire cross-section of the electrode slurry composition is shown, and the enlarged view of the dotted area shows a structure in which fine droplets (small gray circles) of the second solvent are located between the electrode active materials (large circles) to form capillary bridges. Here, the bulk solvent (first solvent) is indicated by a light-colored area, the conductive material is indicated by small black circles, and the binder is indicated by curved lines, respectively.

FIGS. 2A and 2B show photographic images (2A) showing the rheology property of the electrode slurry compositions prepared in Example 1 and Comparative Example 1 according to the present invention, and a graph (2B) of storage modulus (G′) and loss modulus (G″) versus shear stress.

FIG. 3 is a photographic image showing the rheology property of the electrode slurry compositions prepared in Example 1 and Comparative Examples 1 to 3 according to the present invention.

FIG. 4 is a graph of viscosity versus shear rate of the electrode slurry compositions prepared in Example 1 and Comparative Examples 1 to 3 according to the present invention.

FIG. 5 shows (A) a graph of element distribution of binder and conductive material according to thickness (Binder>F element) and (B) a graph of element distribution of binder and conductive material according to thickness (Conductive material>C element) using electron probe microanalysis (EPMA) of the electrodes manufactured in Example 1 (Capillary electrode) and Comparative Example 1 (Pristine electrode) according to the present invention.

FIG. 6 is a graph showing the thickness according to the length of the positive electrodes manufactured in Example 1 (Capillary electrode) and Comparative Example 1 (Pristine electrode) according to the present invention.

FIG. 7 is a graph of voltage profile showing the areal capacity for different mass loadings of a battery using the positive electrode manufactured in Example 1 (Capillary electrode) according to the present invention.

FIG. 8 is a graph showing the specific capacity and Coulombic Efficiency according to the number of cycles of the positive electrodes manufactured in Example 1 (Capillary electrode) and Comparative Example 1 (Pristine electrode) according to the present invention.

### DETAILED DESCRIPTION

The advantages and features of the present invention, and the methods of achieving them, will become clear with reference to the examples described in detail below together with the accompanying drawings. However, the present invention is not limited to the examples disclosed below but will be implemented in various different forms, and these examples are provided only to make the disclosure of the present invention complete and to fully inform those skilled in the art of the scope of the invention to which the present invention pertains, and the present invention is defined only by the scope of the claims.

In describing the present invention, if it is determined that a detailed description of related known technologies may unnecessarily obscure the gist of the present invention, the detailed description thereof will be omitted. When “comprises,” “has,” “consists of,” etc. mentioned in this specification are used, other parts may be added unless “only” is used. In addition, terms such as “comprise” or “have” are intended to designate the presence of features, numbers, steps, components, or combinations thereof described in the specification, and should not be understood as excluding the possibility of the presence or addition of one or more other features, numbers, steps, components, or combinations thereof. In addition, when a component is expressed in the singular, it includes the case of including the plural unless specifically stated otherwise.

In the present specification, the polarity index is based on the Snyder polarity index. The expression “about” used for the polarity index value in the present specification means a range within ±0.3 of the corresponding numerical value, which considers the typical variation range according to measurement methods and conditions.

In the present specification, the “capillary suspension structure” refers to a structure in which a small amount of a second solvent having a different polarity exists in the form of fine droplets in a bulk solvent (first solvent), wherein the fine droplets of the second solvent are selectively located in the voids between solid particles (electrode active material) to form inter-particle bonds by capillary force, thereby remarkably changing the rheological properties of the entire slurry. This concept of capillary suspension is based on the phenomenon that a small amount of secondary fluid forms capillary bridges between solid particles in a liquid-liquid-solid three-phase system.

As described above, the slurry method for manufacturing a conventional electrode shows “drying dynamics” in which the binder and conductive material move to the upper part of the electrode along with the solvent during the slurry drying process, and a “coffee-ring effect” in which the positive electrode active material moves to the edge of the slurry according to the Marangoni flow within the slurry, causing a decrease in adhesion with the current collector, formation of cracks in the electrode, and uneven distribution of the active material within the electrode, thereby limiting the manufacture of high-loading electrodes.

Accordingly, the present invention has the advantages that, by mixing a first solvent and a second solvent of specific components into the electrode slurry composition, the binder, conductive material, and electrode active material can be uniformly distributed during drying, the migration phenomenon of the electrode active material is suppressed to enable the manufacture of a high-loading electrode, adhesion to the current collector is excellent, and the manufacturing process is simple. Furthermore, the life characteristics and electrochemical stability of the high-loading electrode can be remarkably improved.

Another aspect of the present invention relates to an electrode slurry composition for a lithium ion battery comprising: a first solvent; a second solvent; an electrode active material; a binder; and a conductive material; wherein the first solvent has a Snyder polarity index of 5.5 or more, the second solvent has a Snyder polarity index of 4.5 or less, and a volume ratio of the first solvent to the second solvent is 100:2.1 to 5.9.

It is preferable to use a solvent capable of dissolving the binder well as the first solvent, and the polarity index may be 5.5 or more, preferably 6.0 or more, and most preferably 6.5 or more. At this time, if the Snyder polarity index of the first solvent is less than 5.5, it may be mixed with the second solvent depending on the use conditions, making it impossible to form a capillary suspension structure.

In addition, when mixed with the first solvent, the second solvent forms spherical fine droplets having high surface energy due to the polarity difference, and can be induced to be located between the electrode active materials to stabilize the high surface energy, thereby forming a capillary suspension structure. The second solvent may have a Snyder polarity index of 4.5 or less, preferably 3.5 or less, and most preferably 3.0 or less. At this time, if the Snyder polarity index of the second solvent exceeds 4.5, it may be mixed with the first solvent depending on the use conditions, making it impossible to form a capillary suspension structure.

At this time, it is advantageous that the difference in Snyder polarity index between the first solvent and the second solvent is 5.0 or more, preferably 5.5 or more, more preferably 6.0 or more, and most preferably 6.5 or more.

If the difference in Snyder polarity index between the first solvent and the second solvent is less than 5.0, the two solvents may be mixed with each other depending on the use conditions, so that a capillary suspension structure is not formed at all, or the capillary force is weak so that the capillary suspension structure may not be sufficiently formed.

In the case where the difference in Snyder polarity index between the first solvent and the second solvent is 5.5 or more, a gel-like rheological transition in which the storage modulus (G′) of the electrode slurry composition exceeds the loss modulus (G″) is expressed, resulting in the effect that the slurry does not flow down due to gravity after coating and stably maintains its shape, whereas in the case where it is less than 5.5, such gel-like rheological transition is not expressed and a sagging phenomenon of the slurry after coating is observed, so it is preferable that the difference in Snyder polarity index between the first solvent and the second solvent is 5.5 or more.

In addition, in the case where the difference in Snyder polarity index between the first solvent and the second solvent is 6.0 or more, long-term electrochemical stability achieving a capacity retention of 80% or more compared to the initial specific capacity even after 100 cycles during the charge/discharge cycles of the electrode appears, whereas in the case where it is less than 6.0, such long-term electrochemical stability is not secured and the capacity retention rate drops rapidly to less than 80% before 100 cycles of charge/discharge, so it is more preferable that the difference in Snyder polarity index between the first solvent and the second solvent is 6.0 or more.

In particular, in the case where the difference in Snyder polarity index between the first solvent and the second solvent is 6.5 or more, ultra-high energy density electrode characteristics appear in which an areal capacity of 20 mAh/cm² or more is achieved without cracks occurring in the electrode even under ultra-high mass loading conditions of 100 mg/cm² or more, whereas in the case where it is less than 6.5, such ultra-high energy density electrode characteristics do not appear, and cracks occur in the electrode under ultra-high mass loading conditions of 100 mg/cm² or more or the areal capacity remains less than 20 mAh/cm², so it is most preferable that the difference in Snyder polarity index between the first solvent and the second solvent is 6.5 or more.

Specific examples of the first solvent may be water or hydroxyethyl methacrylate or N-methylpyrrolidone or a mixture of two or more thereof, and preferably N-methylpyrrolidone. In the case of the water, it is applicable only to a positive electrode using a positive electrode active material of lithium iron phosphate (LiFePO4, LFP), so its use is limited, whereas the N-methylpyrrolidone has the advantage of being widely applicable to all electrode active materials. Here, the water has a polarity index of about 10.2, and the N-methylpyrrolidone has about 6.7.

Specific examples of the second solvent may be at least one selected from the group consisting of dodecane, hexane, octanol, diisononyl phthalate, paraffin oil, and methyl methacrylate, preferably dodecane or hexane, and most preferably dodecane. Here, the dodecane and hexane have a polarity index of about 0.1, respectively, and the octanol has a polarity index of about 3.4.

Possible examples of the combination of the (first solvent and second solvent) may be at least one selected from the group consisting of (water and dodecane); (water and hexane); (water and octanol); (N-methylpyrrolidone and hexane) and (N-methylpyrrolidone and dodecane). Preferably, it may be at least one selected from the group consisting of (water and octanol); (N-methylpyrrolidone and hexane); and (N-methylpyrrolidone and dodecane), more preferably (water and octanol); (N-methylpyrrolidone and dodecane); or a combination thereof, and most preferably (N-methylpyrrolidone and dodecane).

In the case where the first solvent and the second solvent are composed of the preferred combination, reversible viscosity recovery characteristics (thixotropy) against changes in shear rate are expressed, resulting in the effect that viscosity decreases rapidly during the coating process (under high shear) to enable uniform application and viscosity recovers rapidly immediately after coating (at low shear) to maintain the coating shape, whereas in the case where it is not the preferred combination, such reversible viscosity recovery characteristics are not expressed, and recovery after viscosity reduction during coating is insufficient, resulting in deformation of the coating shape, so the preferred combination is preferable.

In addition, in the case where the first solvent and the second solvent are composed of the more preferred combination, the boiling point of the second solvent is higher than the boiling point of the first solvent during the drying process, resulting in the effect that the fine droplets of the second solvent stably remain between the electrode active materials even while the first solvent evaporates preferentially, so that the capillary force is maintained constant throughout the drying process, whereas in the case where it is not the more preferred combination, such effect of stable maintenance of capillary force throughout the drying process does not appear, and the capillary suspension structure collapses early in the initial stage of drying, so the more preferred combination is more preferable.

In particular, in the case of the combination of N-methylpyrrolidone and dodecane as the first solvent and the second solvent, it can be widely applied regardless of the type of electrode active material, and not only can a densely high-loaded electrode be formed by more evenly and uniformly dispersing the electrode active material, binder, and conductive material, but also the boiling points of N-methylpyrrolidone (boiling point about 202° C.) and dodecane (boiling point about 216° C.) are close, so that the two solvents evaporate at similar rates during the drying process, while the phase separation state due to the polarity difference is maintained until the completion of drying, resulting in the effect that the capillary force acts uniformly and stably throughout the entire drying process, whereas in the case where it is not the most preferred combination, such effect of maintaining uniform capillary force throughout the entire drying process due to the proximity of boiling points does not appear, and the capillary force acts unevenly during the drying process, so the most preferred combination is most preferable.

The volume ratio of the first solvent to the second solvent may be 100:2.1 to 5.9, particularly 100:2.25 to 5.75, preferably 100:2.5 to 5.5, more preferably 100:2.75 to 5.25, and most preferably 100:3 to 5.

At this time, if the volume ratio is less than 100:2.1, the capillary suspension structure appears only in a very narrow region, so that uniform distribution of the binder and conductive material and suppression of migration of the positive electrode active material cannot be expected, and conversely, if it exceeds 100:5.9, the second solvent exists in a phase-separated state in the upper part of the electrode slurry composition, which may significantly reduce the dispersibility of particles or have a negative effect on the coating and drying process of the electrode slurry composition.

That is, even if the difference in polarity index between the first solvent and the second solvent is sufficient, if the volume ratio is outside the appropriate range, the capillary suspension structure is not sufficiently formed, so the difference in polarity index is a necessary condition for the formation of the capillary suspension structure but not a sufficient condition, and stable capillary suspension structure is formed by the fine droplets of the second solvent being effectively located between the electrode active materials only when the volume ratio is within the appropriate range.

In particular, in the case where the difference in Snyder polarity index between the first solvent and the second solvent is 6.0 or more and the volume ratio of the first solvent to the second solvent is 100:2.5 to 5.5, the size of the fine droplets of the second solvent in the capillary suspension is commensurate with the pore size between the electrode active material particles, so that a 3-dimensionally connected capillary network structure is formed, resulting in the effect that isotropic capillary force acts throughout the entire electrode slurry composition, whereas in the case where the difference in polarity index is less than 6.0 or the volume ratio is outside the above range, such isotropic capillary force is not expressed and asymmetrical deviation of active material distribution according to direction within the electrode is observed, so the difference in polarity index of 6.0 or more and the volume ratio of 100:2.5-5.5 are preferable.

The electrode active material may be a positive electrode active material or a negative electrode active material, and preferably a positive electrode active material.

The electrode active material may be at least one selected from the group consisting of LCO series, NCA series, NCM series, LMO series, and LFP series, but is not limited thereto.

Specific examples of the electrode active material may be at least one selected from the group consisting of LCO (LiCoO2), NCM111 (LiNi1/3Co1/3Mn1/3O2), NCM622 (LiNi0.6Co0.2Mn0.2O2), NCM811 (LiNi0.8Co0.1Mn0.1O2), LMO (LiMn2O4), and LNMO (LiNi0.5Mn1.5O4).

The binder may be at least one selected from the group consisting of styrene-butadiene rubber (SBR), polyvinylidene fluoride-co-hexafluoropropylene, polyvinylidene fluoride-co-trichloroethylene, polytetrafluoroethylene (PTFE), polyvinylpyrrolidone, polyethylene oxide, polyarylate, cellulose acetate, cellulose acetate butyrate, cellulose acetate propionate, cyanoethylpullulan, cyanoethylpolyvinylalcohol, cyanoethylcellulose, cyanoethylsucrose, pullulan, and carboxyl methyl cellulose (CMC), but is not limited thereto.

The conductive material may be at least one selected from the group consisting of Super-P, Carbon nano fiber, Vapor Grown Carbon fibers, Ketjen black, Denka black, acetylene black, carbon black, Carbon Nanotube, Multi-Walled Carbon Nanotube, and Ordered Mesoporous Carbon, but is not limited thereto.

The weight ratio of the first solvent, the electrode active material, the binder, and the conductive material may be 100:300 to 400:3 to 10:3 to 10, preferably 100:320 to 380:4 to 8:4 to 8.

In particular, when the weight ratio of the first solvent, the electrode active material, the binder, and the conductive material satisfies the range of 100:320 to 380:4 to 8:4 to 8, the thickness deviation of the manufactured electrode can be significantly reduced.

The electrode slurry composition may have a capillary suspension structure formed in a form in which fine droplets of the second solvent are located between the electrode active materials.

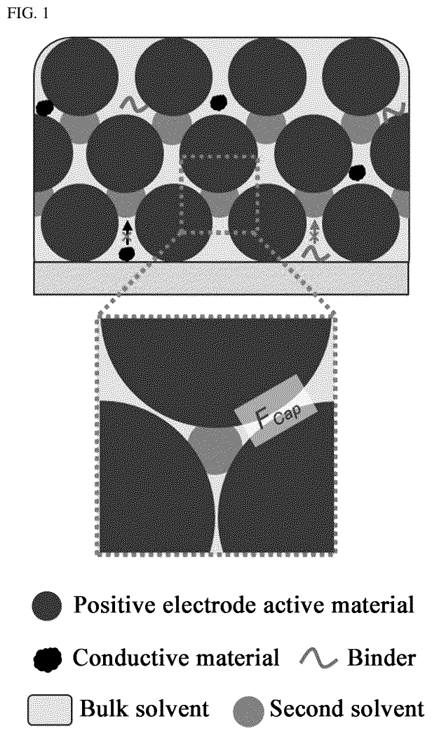

FIG. 1 is a cross-sectional view of an electrode slurry composition according to an embodiment of the present invention.

Referring to FIG. 1, the electrode slurry composition of the present invention shows that a first solvent (bulk solvent) and a second solvent exist simultaneously, wherein the second solvent has a lower polarity than the first solvent so it does not mix with the first solvent and exists separately. It shows that the second solvent forms spherical fine droplets having high surface energy, and forms a capillary suspension structure in a form located between the electrode active materials to stabilize the high surface energy. This capillary suspension structure slows down the migration speed of the binder and conductive material in the electrode slurry composition to enable uniform distribution of the binder and conductive material, and migration of the electrode active material is suppressed by the capillary force applied between the electrode active materials, so that an electrode having a uniform thickness can be formed without cracks occurring.

In particular, in the case where \textcircled{1} the first solvent is N-methylpyrrolidone, \textcircled{2} the second solvent is dodecane, and \textcircled{3} the volume ratio of the first solvent to the second solvent is 100:3 to 5, the storage modulus (G′) of the electrode slurry composition is significantly higher than the loss modulus (G″) by 10 times or more, forming a robust gel network, resulting in the effect that remarkable shear-thinning behavior, in which viscosity decreases rapidly when shear rate increases while exhibiting ultra-high viscosity of 600,000 cP or more at a shear rate of 10-3 s−1, is simultaneously expressed, whereas in the case where any one of the above conditions is not met, such simultaneous expression of ultra-high viscosity and remarkable shear-thinning behavior is not observed, so it is preferable that all of the above conditions are met.

In addition, another aspect of the present invention relates to an electrode for a lithium ion battery manufactured using the electrode slurry composition of the present invention.

The electrode may include a current collector; and an active material layer in which the electrode slurry composition is coated on the current collector.

The current collector may be at least one selected from the group consisting of aluminum (Al), copper (Cu), nickel (Ni), iron (Fe), titanium (Ti), and stainless alloy (SUS).

In addition, another aspect of the present invention relates to a lithium ion battery comprising the electrode of the present invention.

The lithium ion battery may include the electrode as a positive electrode, lithium metal as a negative electrode, a separator, and an electrolyte.

The electrolyte is responsible for the movement of lithium ions between the negative electrode and the positive electrode, and may include an electrolyte solution, a lithium salt, and an organic fluorine compound. The electrolyte may be located between the separator and the positive electrode, or impregnated in the separator.

The electrolyte solution may be at least one selected from the group consisting of ether-based organic solvents, carbonate-based organic solvents, and fluorine-based organic solvents.

The ether-based organic solvent may be at least one selected from the group consisting of 1,2-dimethoxyethane, 1,3-dioxolane, and tetrahydrofuran, but is not limited thereto.

The carbonate-based organic solvent may be at least one selected from the group consisting of ethylene carbonate, propylene carbonate, dimethyl carbonate, diethyl carbonate, ethylmethyl carbonate, fluoroethylene carbonate, difluoroethylene carbonate, fluorodimethyl carbonate, and fluoroethylmethyl carbonate, but is not limited thereto.

The fluorine-based organic solvent may be at least one selected from the group consisting of 1,1,2,2-tetrafluoroethyl-1H,1H,5H-octafluoropentyl ether (TFOFE), 1,1,2,2-tetrafluoroethyl-2,2,2,3-tetrafluoropropyl ether (TTE), bis(2,2,2-trifluoroethyl) ether (BTFE), 1,1,2,2-tetrafluoroethyl-2,2,2-trifluoroethyl ether (TFTFE), methoxynonafluorobutane (MOFB), and ethoxynonafluorobutane (EOFB), but is not limited thereto.

The lithium salt may be at least one selected from the group consisting of LiN(SO2F)2, LiN(SO2C2F5)2, LiN(CF3SO2)2, LiPF6, LiBF4, LiCIO4, LiCF3SO3, LiC4F9O3, LiC6H5SO3, LiSCN, LiB(C2O4)2, and LiDFOP, but is not limited thereto.

In addition, another aspect of the present invention relates to a device comprising the lithium ion battery of the present invention, wherein the device is at least one selected from a communication device, a transportation device, an electronic device, and an energy storage device.

The transportation device may be one selected from an electric vehicle, a hybrid electric vehicle, and a plug-in hybrid electric vehicle.

In addition, another aspect of the present invention relates to a method for manufacturing an electrode for a lithium ion battery comprising: (a) preparing an electrode slurry precursor comprising a first solvent, an electrode active material, a binder, and a conductive material; (b) mixing a second solvent into the electrode slurry precursor to prepare an electrode slurry composition for a lithium ion battery; and (c) coating the electrode slurry composition on a substrate and then drying it to manufacture an electrode for a lithium ion battery.

The electrode slurry composition does not mix the second solvent together with the first solvent, the electrode active material, the binder, and the conductive material, but by mixing the second solvent into the electrode slurry precursor, the second solvent can be selectively located on the uniformly dispersed electrode active material particles to form a more stable capillary suspension structure.

The first solvent may be water or hydroxyethyl methacrylate, and the second solvent may be at least one selected from the group consisting of diisononyl phthalate, paraffin oil, and methyl methacrylate.

The difference in Snyder polarity index between the first solvent and the second solvent may be 5.0 or more, preferably 5.5 or more, more preferably 6.0 or more, and most preferably 6.5 or more.

It is preferable to use a solvent capable of dissolving the binder well as the first solvent, and the polarity index may be 5.5 or more, preferably 6.0 or more, and most preferably 6.5 or more.

Specific examples of the first solvent may be water or hydroxyethyl methacrylate or N-methylpyrrolidone, and preferably N-methylpyrrolidone.

The second solvent may have a Snyder polarity index of 4.5 or less, preferably 3.5 or less, and most preferably 3.0 or less.

Specific examples of the second solvent may be at least one selected from the group consisting of diisononyl phthalate, paraffin oil, methyl methacrylate, dodecane, hexane, and octanol, preferably dodecane or hexane, and most preferably dodecane.

The volume ratio of the first solvent to the second solvent may be 100:2.1 to 5.9, particularly 100:2.25 to 5.75, preferably 100:2.5 to 5.5, more preferably 100:2.75 to 5.25, and most preferably 100:3 to 5.

The electrode slurry composition may have a capillary suspension structure formed in a form in which fine droplets of the second solvent are located between the electrode active materials.

The coating may be performed by one or more methods selected from the group consisting of Dr. blade coating, Roll coating, Bar coating, Slot die coating, Comma coating, Knife coating, Gravure coating, Micro-Gravure coating, Dip-coating, Flow coating, Spin-coating, and Spray coating.

After the coating, the electrode slurry composition may be dried at 60 to 160° C. for 2 to 4 hours, preferably at 80 to 140° C. for 2 to 4 hours, more preferably at 100 to 120° C. for 2 to 4 hours, and most preferably at 105 to 115° C. for 2 to 4 hours.

At this time, if the drying temperature is less than 60° C. or the drying time is less than 2 hours, complete drying of the process solvent may be restricted, and conversely, if the drying temperature exceeds 160° C. or the drying time exceeds 4 hours, adverse effects due to drying dynamics and the coffee-ring effect may be significantly exerted.

Hereinafter, the present invention will be described in more detail through examples, etc., but the scope and content of the present invention cannot be interpreted as being reduced or limited by the examples, etc. below.

### Example 1

N-methylpyrrolidone (NMP) as a first solvent, a positive electrode active material (NCM), a conductive material (super P), and a binder (PVdF) were mixed in a weight ratio of 22:75:1.5:1.5 to prepare an electrode slurry precursor. Then, 4 parts by volume of dodecane as a second solvent were mixed based on 100 parts by volume of NMP in the electrode slurry precursor to prepare an electrode slurry composition having a capillary suspension structure. Then, the electrode slurry composition was cast on an aluminum foil (Al foil) and dried at 140° C. for 3 hours to manufacture a positive electrode.

### Comparative Example 1

NMP as a first solvent, a positive electrode active material (NCM), a conductive material (super P), and a binder (PVdF) were mixed in a weight ratio of 22:75:1.5:1.5 to prepare a slurry, and the slurry was cast on an aluminum foil (Al foil) and dried at 140° C. for 3 hours to manufacture a positive electrode.

### Comparative Example 2

A positive electrode was manufactured in the same manner as in Example 1, except that an electrode slurry composition was prepared by mixing 2 parts by volume of dodecane as a second solvent with respect to 100 parts by volume of NMP in the electrode slurry precursor.

### Comparative Example 3

A positive electrode was manufactured in the same manner as in Example 1, except that an electrode slurry composition was prepared by mixing 6 parts by volume of dodecane as a second solvent with respect to 100 parts by volume of NMP in the electrode slurry precursor.

### Experimental Example 1-1. Rheological Properties

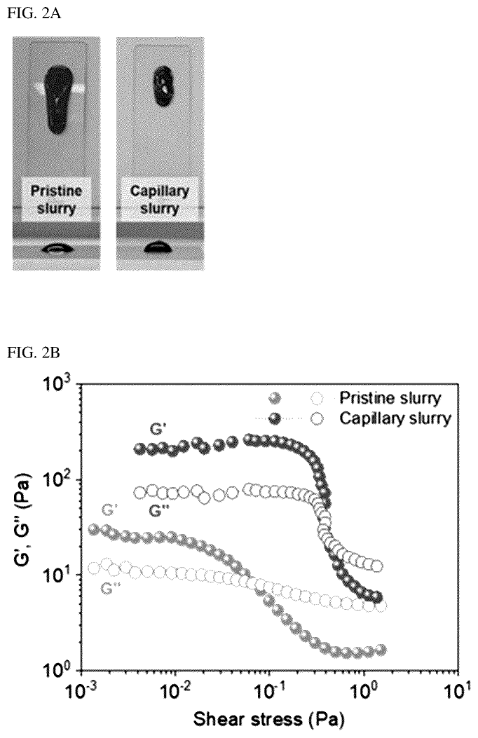

The rheological properties (Rheology property) of the electrode slurry compositions prepared in Example 1 and Comparative Example 1 were measured, and the results are shown in FIGS. 2A and 2B.

FIGS. 2A and 2B show photographic images (2A) showing the rheology property of the electrode slurry compositions prepared in Example 1 and Comparative Example 1, and a graph (2B) of storage modulus (G′) and loss modulus (G″) versus shear stress.

As shown in FIGS. 2A and 2B, in the electrode slurry composition of Example 1 in which a capillary suspension structure was formed, two types of solvents having different affinities with the positive electrode active material coexist due to the polarity difference between the positive electrode active material and the first and second solvents, thereby forming a capillary suspension structure, and it was confirmed that capillary force is formed by this capillary suspension structure, thereby forming an electrode slurry composition having high viscosity.

### Experimental Example 1-2. Rheological Properties

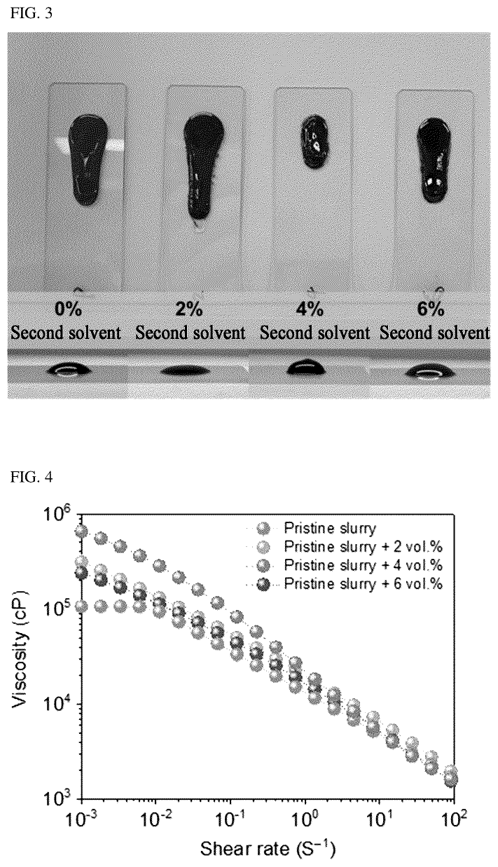

The rheological properties (Rheology property) of the electrode slurry compositions prepared in Example 1 and Comparative Examples 1 to 3 were measured, and the results are shown in FIGS. 3 and 4.

FIG. 3 is a photographic image showing the rheology property of the electrode slurry compositions prepared in Example 1 and Comparative Examples 1 to 3.

As shown in FIG. 3, in the case of Example 1, it was confirmed to have high viscosity as dodecane, the second solvent, was mixed in an appropriate amount. On the other hand, in the case of Comparative Examples 1 and 2, when the second solvent was not mixed at all or its amount was small, the capillary suspension structure appeared only in a very narrow region, showing a low viscosity state. Also, in the case of Comparative Example 3, it was confirmed that the capillary suspension structure was not properly formed due to too much content of the second solvent, showing a low viscosity state.

FIG. 4 is a graph of viscosity versus shear rate of the electrode slurry compositions prepared in Example 1 and Comparative Examples 1 to 3. In FIG. 4, the data marked as ‘Pristine Slurry’, ‘Pristine Slurry+2 vol %’, ‘Pristine Slurry+4 vol %’, and ‘Pristine Slurry+6 vol %’ are data of electrode slurry compositions prepared in Comparative Example 1, Comparative Example 2, Example 1, and Comparative Example 3, respectively.

Referring to FIG. 4, it was confirmed that when the shear rate was 10-3 s−1, Example 1 had a high viscosity of 657,740 cP, whereas Comparative Examples 1 to 3 showed low viscosities of 106,490 cP (Comparative Example 1), 239,420 cP (Comparative Example 3), and 313,530 cP (Comparative Example 2).

From the results of FIG. 4, based on the viscosity at a shear rate of 10-3 s−1, it was confirmed that the viscosity of Example 1 was about 6.2 times higher than that of Comparative Example 1, and about 2.1 times to 2.7 times higher than that of Comparative Example 2 or 3. This is interpreted that sufficient capillary suspension structure is formed and viscosity is remarkably improved only in Example 1 where the content of the second solvent falls within the appropriate range (100:2.1 to 5.9), whereas in Comparative Example 2 or Comparative Example 3 where the content of the second solvent is outside the above range, the capillary suspension structure is insufficiently formed or not properly formed, so the viscosity improvement is limited.

In addition, under high shear conditions where the shear rate is 102 s−1, it can be confirmed that the viscosities of Example 1 and Comparative Examples 1 to 3 all converge to a similar level, which means that the electrode slurry composition of Example 1 has remarkable shear-thinning characteristics showing ultra-high viscosity at low shear and viscosity reduction at high shear simultaneously. Such characteristics correspond to ideal rheological behavior in which uniform application is possible with low viscosity during the coating process (high shear condition), and the shape of the coating film is stably maintained with high viscosity immediately after coating (low shear condition).

Summing up the results of Example 1 and Comparative Examples 1 to 3, it can be confirmed that even if the difference in polarity index between the first solvent and the second solvent is the same, if the volume ratio of the first solvent and the second solvent is outside the appropriate range, the capillary suspension structure is not sufficiently formed. Specifically, in Comparative Example 1 where the second solvent does not exist, the capillary suspension structure was not formed at all, and when the content of the second solvent was insufficient, the number of fine droplets of the second solvent was insufficient, so capillary bridges were formed only sporadically between the electrode active materials, and the capillary suspension structure appeared only in a very narrow region, and when the content of the second solvent was excessive, the second solvent existed in a phase-separated state in the upper part of the electrode slurry composition, so the fine droplets could not be located between the electrode active materials and the capillary suspension structure was not properly formed, whereas only in Example 1 where the content of the second solvent was in the appropriate range, the fine droplets of the second solvent were uniformly located between the electrode active materials to form a stable capillary suspension structure, and accordingly, it was confirmed that a remarkably high viscosity of 657,740 cP and gel-like rheological transition (G′>G″) were expressed.

### Experimental Example 2. Evaluation of Element Distribution of Binder and Conductive Material

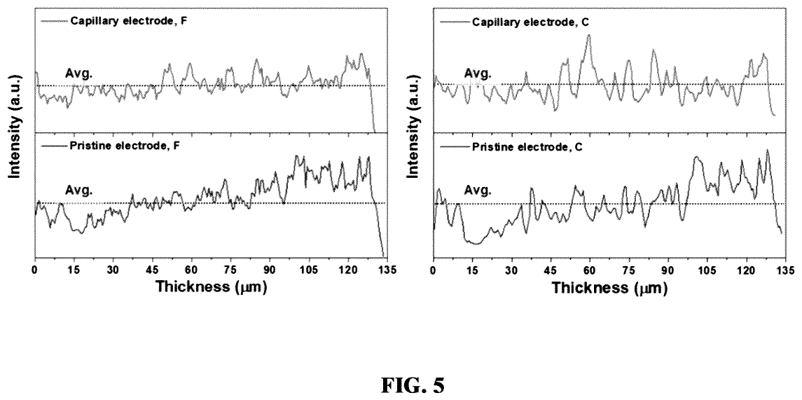

Using electron probe microanalysis (EPMA), the distribution of binder and conductive material according to the thickness of the positive electrodes manufactured in Example 1 and Comparative Example 1 was measured, and the results are shown in FIG. 5.

FIG. 5 shows (A) a graph of element distribution of binder and conductive material according to thickness (Binder>F element) and (B) a graph of element distribution of binder and conductive material according to thickness (Conductive material>C element) using electron probe microanalysis (EPMA) of the electrodes manufactured in Example 1 (Capillary electrode) and Comparative Example 1 (Pristine electrode).

As shown in FIG. 5, it can be seen that in the positive electrode manufactured in Example 1, the added fine dropletized second solvent is located between the positive electrode active materials to stabilize the surface energy, forming a capillary suspension structure, and through this structure, the migration speed of the binder and conductive material in the electrode slurry composition is slowed down to show uniform distribution of the binder and conductive material.

Analyzing FIG. 5 in more detail, in Comparative Example 1 (Pristine electrode), the intensity of the binder (F element) and conductive material (C element) signals shows an uneven gradient that increases from the lower part of the electrode (current collector side, thickness ~0 μm) to the upper part (electrode surface side, thickness ~135 μm), which corresponds to a typical phenomenon in which the binder and conductive material move to the upper layer of the electrode by drying dynamics. On the other hand, in Example 1, the intensity of F and C element signals is generally uniformly distributed around the average value (Avg.) throughout the entire electrode thickness direction, and no intensity gradient between the upper and lower parts was observed. These results confirm that the upward migration of the binder and conductive material during drying was effectively suppressed by the capillary suspension structure.

### Experimental Example 3. Evaluation of Electrode Thickness

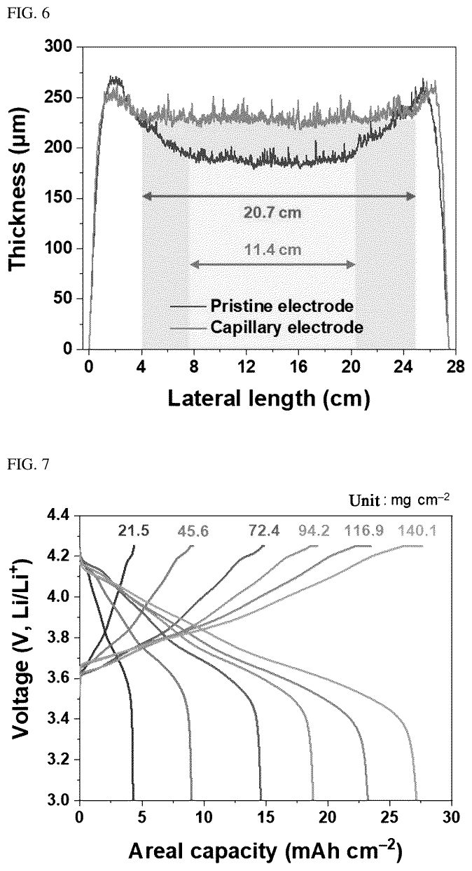

The thickness according to the length of the positive electrodes manufactured in Example 1 (Capillary electrode) and Comparative Example 1 (Pristine electrode) was analyzed, and the results are shown in FIG. 6.

FIG. 6 is a graph showing the thickness according to the length of the positive electrodes manufactured in Example 1 (Capillary electrode) and Comparative Example 1 (Pristine electrode).

As shown in FIG. 6, the electrode of Comparative Example 1 had very large thickness deviation according to position, and the section where a constant thickness was secured was very short at 11.4 cm, but the electrode of Example 1 had remarkably improved thickness deviation according to position, and the section where a constant thickness was secured was 20.7 cm. Through this, it could be confirmed that migration of the active material is suppressed by the capillary force applied between the positive electrode active materials in the electrode slurry composition of Example 1, so that a positive electrode having a uniform height without cracks occurring can be obtained.

Analyzing FIG. 6 in more detail, the thickness of the electrode of Comparative Example 1 fluctuates remarkably at both edges (around lateral length ~0 cm and ~24 cm), which is interpreted as the formation of uneven thickness distribution due to the movement of the positive electrode active material to the edges by the coffee-ring effect during the drying process. In particular, the section where a constant thickness (about 150 μm) is secured in Comparative Example 1 is only about 11.4 cm, so the effective area of the electrode is largely limited. On the other hand, the electrode of Example 1 maintains a constant thickness of about 200 μm in the section of about 20.7 cm ranging from about 4 cm to about 24 cm, improving the uniform thickness section by about 1.8 times compared to Comparative Example 1. This is a result of effectively preventing the coffee-ring effect by suppressing the horizontal movement of the positive electrode active material particles by the capillary force within the capillary suspension structure.

### Experimental Example 4. Evaluation of Electrochemical Performance

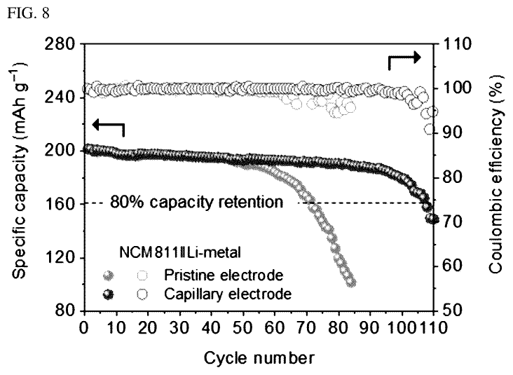

A lithium ion battery was manufactured using the positive electrodes manufactured in Example 1 (Capillary electrode) and Comparative Example 1 (Pristine electrode), a negative electrode using lithium metal, and an electrolyte containing 10 wt % of FEC and 2 wt % of VC in 1 M LiPF6 EC/DEC (1/1, v/v) electrolytic salt. The electrochemical performance of the manufactured lithium ion battery was evaluated at room temperature and under conditions of 0.05 C-rate or 0.1 C-rate, and the results are shown in FIGS. 7 and 8.

FIG. 7 is a graph of voltage profile showing the areal capacity for different mass loadings of a battery using the positive electrode manufactured in Example 1 (Capillary electrode).

As shown in FIG. 7, the positive electrode of Example 1 could achieve an areal capacity of about 27 mAh/cm² at a mass loading of 140 mg/cm².

FIG. 8 is a graph showing the specific capacity and Coulombic Efficiency according to the number of cycles of the positive electrodes manufactured in Example 1 (Capillary electrode) and Comparative Example 1 (Pristine electrode).

As shown in FIG. 8, it was confirmed that the positive electrode of Example 1 (~8 mAh cm−2), which has a higher loading than commercialized positive electrodes (~4 mAh cm−2), enables stable capacity securing even in charge/discharge repeated 100 times or more during life evaluation, and it could be confirmed that both specific capacity and Coulombic Efficiency were superior to the electrode of Comparative Example 1 in which a capillary suspension structure was not formed.

### Example 2

Water (H₂O) as a first solvent, a positive electrode active material (LFP), a conductive material (super P), and a binder (SBR/CMC) were mixed in a weight ratio of 22:75:1.5:1.5 to prepare an electrode slurry precursor. Then, 4 parts by volume of octanol as a second solvent were mixed based on 100 parts by volume of water in the electrode slurry precursor to prepare an electrode slurry composition having a capillary suspension structure. Then, the electrode slurry composition was cast on an aluminum foil (Al foil) and dried at 110° C. for 3 hours to manufacture a positive electrode.

### Example 3

N-methylpyrrolidone (NMP) as a first solvent, a positive electrode active material (NCM811), a conductive material (super P), and a binder (PVdF) were mixed in a weight ratio of 22:75:1.5:1.5 to prepare an electrode slurry precursor. Then, 4 parts by volume of hexane as a second solvent were mixed based on 100 parts by volume of NMP in the electrode slurry precursor to prepare an electrode slurry composition having a capillary suspension structure. Then, the electrode slurry composition was cast on an aluminum foil (Al foil) and dried at 80° C. for 2 hours to manufacture a positive electrode.

### Example 4

A positive electrode was manufactured in the same manner as in Example 1, except that an electrode slurry composition was prepared by mixing 3 parts by volume of dodecane as a second solvent with respect to 100 parts by volume of NMP in the electrode slurry precursor.

### Example 5

A positive electrode was manufactured in the same manner as in Example 1, except that an electrode slurry composition was prepared by mixing 5 parts by volume of dodecane as a second solvent with respect to 100 parts by volume of NMP in the electrode slurry precursor.

### Comparative Example 4

N-methylpyrrolidone (NMP) as a first solvent, a positive electrode active material (NCM811), a conductive material (super P), and a binder (PVdF) were mixed in a weight ratio of 22:75:1.5:1.5 to prepare an electrode slurry precursor. Then, 4 parts by volume of octanol as a second solvent were mixed based on 100 parts by volume of NMP in the electrode slurry precursor to prepare an electrode slurry composition. Then, the electrode slurry composition was cast on an aluminum foil (Al foil) and dried at 140° C. for 3 hours to manufacture a positive electrode.

### Comparative Example 5

N-methylpyrrolidone (NMP) as a first solvent, a positive electrode active material (NCM811), a conductive material (super P), and a binder (PVdF) were mixed in a weight ratio of 22:75:1.5:1.5 to prepare an electrode slurry precursor. Then, 4 parts by volume of ethanol (Snyder polarity index of about 4.3) as a second solvent were mixed based on 100 parts by volume of NMP in the electrode slurry precursor to prepare an electrode slurry composition. Then, the electrode slurry composition was cast on an aluminum foil (Al foil) and dried at 140° C. for 3 hours to manufacture a positive electrode.

### Experimental Example 5. Confirmation of Capillary Suspension Structure Formation

For the electrode slurry compositions prepared in Examples 1 to 5 and Comparative Examples 1, 4, and 5, the formation of a capillary suspension structure was confirmed through optical microscope observation and rheology measurement, and the results are shown in Table 1 below.

TABLE 1
Results of Confirmation of Capillary Suspension Structure Formation

| | | | | Snyder | Capillary | | |
|---|---|---|---|---|---|---|---|
| | | | Volume | Polarity | Suspension | Gel-like | |
| | 1^{st} | 2^{nd} | Ratio | Index | Structure | Transition | |
| | Solvent | Solvent | (1st:2nd) | Difference | Formation | (G′ > G″) | Remarks |
| Example 1 | NMP | Dodecane | 100:4 | 6.6 | ∘ | ∘ | |
| Example 2 | Water | Octanol | 100:4 | 6.8 | ∘ | ∘ | |
| Example 3 | NMP | Hexane | 100:4 | 6.6 | ∘ | ∘ | |
| Example 4 | NMP | Dodecane | 100:3 | 6.6 | ∘ | ∘ | |
| Example 5 | NMP | Dodecane | 100:5 | 6.6 | ∘ | ∘ | |
| Comp. Ex. 1 | NMP | — | — | — | x | x | 2nd solvent |
| | | | | | | | not added |
| Comp. Ex. 4 | NMP | Octanol | 100:4 | 3.3 | x | x | Insufficient |
| | | | | | | | polarity difference |
| Comp. Ex. 5 | NMP | Ethanol | 100:4 | 2.4 | x | x | Insufficient |
| | | | | | | | polarity difference |

(∘: Formed/Expressed, x: Not formed/Not expressed)

As shown in Table 1, in Examples 1 to 5, it was observed through optical microscope observation that fine droplets of the second solvent were located between the electrode active material particles to form capillary bridges, and gel-like rheological transition in which the storage modulus (G′) exceeds the loss modulus (G″) was also confirmed in rheology measurement, so it was determined that a capillary suspension structure was formed.

Specifically, Example 1 (NMP and dodecane, Snyder polarity index difference 6.6), Example 2 (water and octanol, polarity index difference 6.8), Example 3 (NMP and hexane, polarity index difference 6.6), Example 4 (NMP and dodecane 3 parts by volume, polarity index difference 6.6), and Example 5 (NMP and dodecane 5 parts by volume, polarity index difference 6.6) all had a difference in Snyder polarity index between the first solvent and the second solvent of 5.0 or more and a volume ratio within the range of 100:2.1 to 5.9, and formation of a capillary suspension structure and gel-like rheological transition were confirmed in all of them. On the other hand, in Comparative Example 1 (second solvent not added), a capillary suspension structure was not formed at all, and in Comparative Example 4 (NMP and octanol, polarity index difference 3.3) and Comparative Example 5 (NMP and ethanol, polarity index difference 2.4), a capillary suspension structure was not formed even though the second solvent was added. This is interpreted that because the difference in Snyder polarity index between the first solvent and the second solvent in Comparative Examples 4 and 5 was 3.3 and 2.4, respectively, which is less than 5.0, the second solvent could not form fine droplets and was partially mixed with the first solvent or existed in an unstable state, so that capillary bridges were not formed between the electrode active materials.

In particular, ethanol (polarity index about 4.3) of Comparative Example 5 had a difference in polarity index from N-methylpyrrolidone (polarity index about 6.7) of only 2.4, so the two solvents had a strong tendency to be miscible, and accordingly, the second solvent could not exist as a separate fine droplet phase but was dissolved in the first solvent, making the formation of a capillary suspension structure fundamentally impossible. From the above results, it was confirmed that in order to form a capillary suspension structure, the difference in Snyder polarity index between the first solvent and the second solvent must be 5.0 or more, and if the difference in polarity index is less than this, a capillary suspension structure is not formed even if the volume ratio is within the appropriate range.

### Experimental Example 6. Evaluation of Electrode Thickness Uniformity

For the positive electrodes manufactured in Examples 1, 4, and 5 and Comparative Examples 1 to 3, the thickness according to the length of the positive electrode was analyzed to compare the length of the section where a constant thickness was secured, and the results are shown in Table 2 below.

TABLE 2
Results of Evaluation of Electrode Thickness Uniformity

| | Example 1 | Example 4 | Example 5 | Comp. Ex. 1 | Comp. Ex. 2 | Comp. Ex. 3 |
|---|---|---|---|---|---|---|
| 2nd Solvent | Dodecane | Dodecane | Dodecane | — | Dodecane | Dodecane |
| Volume Ratio | 100:4 | 100:3 | 100:5 | — | 100:2 | 100:6 |
| (1st:2nd) | | | | | | |
| Uniform thickness | 20.7 | 18.5 | 19.2 | 11.4 | 13.8 | 12.1 |
| section (cm) | | | | | | |
| Improvement ratio | 1.8 times | 1.6 times | 1.7 times | 1.0 times | 1.2 times | 1.1 times |
| vs. Comp. Ex. 1 | | | | | | |

As shown in Table 2, in Example 1 (100:4), Example 4 (100:3), and Example 5 (100:5) where the volume ratio falls within the range of claims 1 (100:2.1 to 5.9), all showed remarkably improved uniform thickness sections (20.7 cm, 18.5 cm, 19.2 cm, respectively) compared to Comparative Example 1 (11.4 cm). This is a result of effective suppression of horizontal migration of the active material as the capillary suspension structure was sufficiently formed when the volume ratio was within the appropriate range. In particular, in Example 1 where the volume ratio was 100:4, the uniform thickness section was the best at 20.7 cm, and in Example 4 (18.5 cm) where the volume ratio was 100:3 and Example 5 (19.2 cm) where the volume ratio was 100:5, the uniform thickness sections were improved by about 1.6 times and 1.7 times, respectively, compared to Comparative Example 1. On the other hand, in Comparative Example 2 where the volume ratio was 100:2, which is outside the above range, the uniform thickness section was 13.8 cm, showing only a slight improvement compared to Comparative Example 1 (11.4 cm), and was at a remarkably lower level compared to Examples 1 to 5. This is interpreted that because the number of fine droplets of the second solvent was insufficient, the capillary suspension structure appeared only in a very narrow region, so that the suppression of the coffee-ring effect was limited.

In addition, in Comparative Example 3 (volume ratio 100:6), the second solvent was excessive and existed in a phase-separated state in the upper part of the electrode slurry composition, so that the capillary suspension structure was not properly formed, and accordingly, it was confirmed that the uniform thickness section remained at a level similar to that of Comparative Example 1.

### Experimental Example 7. Evaluation of Adhesive Strength

For the positive electrodes manufactured in Example 1 and Comparative Example 1, the adhesive strength between the electrode mixture layer and the current collector was evaluated using a 180° peel test, and the results are as follows.

As a result of the 180° peel test, the positive electrode manufactured in Example 1 showed remarkably improved adhesive strength compared to the positive electrode manufactured in Comparative Example 1. In Comparative Example 1 (Pristine electrode), a drying behavior in which the binder moves to the upper part of the electrode along the evaporation direction of the solvent occurred during the drying process, so that the binder content significantly decreased at the lower part of the electrode mixture layer (current collector interface side). It was confirmed that the adhesive strength between the current collector and the electrode mixture layer decreased due to this uneven distribution of the binder. This is consistent with the EPMA analysis result of Experimental Example 2, in which the binder (F element) signal intensity of Comparative Example 1 showed an uneven gradient that increased from the lower part to the upper part of the electrode.

On the other hand, in Example 1 (Capillary electrode), the upward migration of the binder during drying was effectively suppressed by the capillary suspension structure, so that the binder was uniformly distributed throughout the electrode mixture layer. Accordingly, sufficient binder remained near the current collector interface, and it was confirmed that the adhesive strength between the electrode mixture layer and the current collector was remarkably improved compared to Comparative Example 1. These results are also consistent with the EPMA analysis result of Experimental Example 2, in which the binder (F element) signal of Example 1 was uniformly distributed throughout the electrode thickness direction.

From the above results, it was confirmed that the capillary suspension structure formed by the electrode slurry composition of the present invention contributes not only to the improvement of rheological properties of the electrode slurry and the improvement of electrode thickness uniformity, but also to the improvement of adhesive strength with the current collector through uniform distribution of the binder.

Although the embodiments of the present invention have been described above, those skilled in the art will be able to variously modify and change the present invention by addition, change, deletion, or addition of components without departing from the spirit of the present invention described in the claims, and this will also be said to be included within the scope of rights of the present invention.

What is claimed is:

1. An electrode slurry composition for a lithium ion battery comprising: a first solvent; a second solvent; an electrode active material; a binder; and a conductive material;
wherein the first solvent has a Snyder polarity index of 5.5 or more,
the second solvent has a Snyder polarity index of 4.5 or less, and
a volume ratio of the first solvent and the second solvent is 100:2.1 to 5.9.

2. The electrode slurry composition for a lithium ion battery according to claim 1,
wherein a difference in Snyder polarity index between the first solvent and the second solvent is 5.0 or more.

3. The electrode slurry composition for a lithium ion battery according to claim 1,
wherein the first solvent is at least one selected from the group consisting of N-methylpyrrolidone (NMP), water, and hydroxyethyl methacrylate, and
the second solvent is at least one selected from the group consisting of diisononyl phthalate, paraffin oil, dodecane, hexane, octanol, and methyl methacrylate.

4. The electrode slurry composition for a lithium ion battery according to claim 1,
wherein (the first solvent and the second solvent) are a combination of at least one selected from the group consisting of (N-methylpyrrolidone (NMP) and dodecane); (water and diisononyl phthalate); (water and paraffin oil); (water and methyl methacrylate); and
(hydroxyethyl methacrylate and paraffin oil).

5. The electrode slurry composition for a lithium ion battery according to claim 1,
wherein (the first solvent and the second solvent) are a combination of at least one selected from the group consisting of (water and octanol); (N-methylpyrrolidone and hexane);
and (N-methylpyrrolidone and dodecane).

6. The electrode slurry composition for a lithium ion battery according to claim 1,
wherein a volume ratio of the first solvent and the second solvent is 100:2.25 to 5.75.

7. The electrode slurry composition for a lithium ion battery according to claim 1,
wherein a difference in Snyder polarity index between the first solvent and the second solvent is 6.0 or more, and
a volume ratio of the first solvent to the second solvent is 100:2.5 to 5.5.

8. The electrode slurry composition for a lithium ion battery according to claim 1,
wherein the electrode active material is at least one selected from the group consisting of LCO series, NCA series, NCM series, LMO series, and LFP series,
the binder is at least one selected from the group consisting of styrene-butadiene rubber (SBR), polyvinylidene fluoride-co-hexafluoropropylene, polyvinylidene fluoride-co-trichloroethylene, polytetrafluoroethylene (PTFE), polyvinylpyrrolidone, polyethylene oxide, polyarylate, cellulose acetate, cellulose acetate butyrate, cellulose acetate propionate, cyanoethylpullulan, cyanoethylpolyvinylalcohol, cyanoethylcellulose, cyanoethylsucrose, pullulan, and carboxyl methyl cellulose (CMC), and
the conductive material is at least one selected from the group consisting of Super-P, Carbon nano fiber, Vapor Grown Carbon fibers, Ketjen black, Denka black, acetylene black, carbon black, Carbon Nanotube, Multi-Walled Carbon Nanotube, and Ordered Mesoporous Carbon.

9. The electrode slurry composition for a lithium ion battery according to claim 1,
wherein the electrode slurry composition has a capillary suspension structure formed in a form in which fine droplets of the second solvent are located between the electrode active materials.

10. The electrode slurry composition for a lithium ion battery according to claim 1,
wherein the first solvent is N-methylpyrrolidone,
the second solvent is dodecane, and
a volume ratio of the first solvent and the second solvent is 100:3 to 5.

11. An electrode for a lithium ion battery manufactured using the electrode slurry composition of claim 1.

12. A lithium ion battery comprising the electrode of claim 11.

13. A device comprising the lithium ion battery of claim 12, wherein the device is at least one selected from a communication device, a transportation device, an electronic device, and an energy storage device.

14. The device according to claim 13, wherein the transportation device is one selected from an electric vehicle, a hybrid electric vehicle, and a plug-in hybrid electric vehicle.

15. A method for manufacturing an electrode for a lithium ion battery comprising:
(a) preparing an electrode slurry precursor comprising a first solvent, an electrode active material, a binder, and a conductive material;
(b) mixing a second solvent into the electrode slurry precursor to prepare an electrode slurry composition for a lithium ion battery; and
(c) coating the electrode slurry composition on a substrate and then drying it to manufacture an electrode for a lithium ion battery;
wherein the first solvent has a Snyder polarity index of 5.5 or more,
the second solvent has a Snyder polarity index of 4.5 or less, and
a volume ratio of the first solvent and the second solvent is 100:2.1 to 5.9.

16. The method for manufacturing an electrode for a lithium ion battery according to claim 15,
wherein a difference in Snyder polarity index between the first solvent and the second solvent is 5.0 or more.

17. The method for manufacturing an electrode for a lithium ion battery according to claim 15,
wherein the first solvent is at least one selected from the group consisting of N-methylpyrrolidone (NMP), water, and hydroxyethyl methacrylate, and
the second solvent is at least one selected from the group consisting of diisononyl phthalate, paraffin oil, dodecane, hexane, octanol, and methyl methacrylate.

18. The method for manufacturing an electrode for a lithium ion battery according to claim 15,
wherein (the first solvent and the second solvent) are a combination of at least one selected from the group consisting of (N-methylpyrrolidone (NMP) and dodecane); (water and diisononyl phthalate); (water and paraffin oil); (water and methyl methacrylate); and
(hydroxyethyl methacrylate and paraffin oil).

19. The method for manufacturing an electrode for a lithium ion battery according to claim 15,
wherein (the first solvent and the second solvent) are a combination of at least one selected from the group consisting of (water and octanol); (N-methylpyrrolidone and hexane);
and (N-methylpyrrolidone and dodecane).

20. The method for manufacturing an electrode for a lithium ion battery according to claim 15,
wherein a volume ratio of the first solvent and the second solvent is 100:2.25 to 5.75.

21. The method for manufacturing an electrode for a lithium ion battery according to claim 15,
wherein a difference in Snyder polarity index between the first solvent and the second solvent is 6.0 or more, and
a volume ratio of the first solvent to the second solvent is 100:2.5 to 5.5.
